(19) United States
(12) Patent Application Publication
(10) Pub. No.: US 2012/0264624 A1
(43) Pub. Date: Oct. 18, 2012

(54) METHOD AND DEVICE FOR DETECTING ANALYTES IN A SAMPLE LIQUID

(75) Inventors: Bernd Drescher, Oberhausen (DE); Claudia Ehle, Penzberg (DE); Leonhard Geissler, Tutzing (DE); Hans-Juergen Mueller, Bernried (DE); Takenori Okusa, Mito-shi, Ibaraki-ken (JP); Hubert Paul, Wielenbach (DE)

(73) Assignee: ROCHE DIAGNOSTICS OPERATIONS, INC., Indianapolis, IN (US)

(21) Appl. No.: 13/455,568

(22) Filed: Apr. 25, 2012

Related U.S. Application Data
(63) Continuation of application No. PCT/EP2010/063452, filed on Sep. 14, 2010.

(30) Foreign Application Priority Data
Oct. 28, 2009 (EP) 09174345.0

(51) Int. Cl. C40B 60/12; C40B 30/00

(52) U.S. Cl. 506/7; 506/39

(57) ABSTRACT

A method for detecting analytes in a sample liquid is provided in which the sample liquid is subjected to a mixing treatment on a surface of a support having in particular immobilized reactants, wherein an in particular trough-like vessel with an essentially flat bottom as a support surface for the immobilized reactants is used as the vessel for the sample liquid. The sample liquid is moved relative to the immobilized reactants by an oscillating movement of the vessel during the mixing treatment in one direction, typically along a line or a curve. In addition, a device is provided for carrying out the method according to the present disclosure.

### CROSS-REFERENCE TO RELATED APPLICATIONS

This application is a continuation of International Application No. PCT/EP2010/063452, filed 14 Sep. 2010, which claims the benefit of European Patent Application No. 09174345.0, filed 28 Oct. 2009, the disclosure of which is hereby incorporated by reference in its entirety.

### BACKGROUND

The present disclosure concerns methods for detecting analytes in a sample liquid and devices for carrying out said method.

The method described in, for example, EP 1 604 734 A2 (US 2006/0019243 A1), utilizes a jet directed towards the sample liquid or support with a stream of gas that sweeps across the support surface in order to improve the binding between the analyte and reactant, wherein the intermixing is improved by the stream of gas that impinges on the sample liquid which results in an improved and accelerated binding between the analyte and reactant.

Although this disclosed method produces good results in practice, the method is quite complicated and in particular the associated device is relatively complex. The stream of gas evaporates the sample liquid and a corresponding jet must be allocated to each support. Furthermore, with such gas feeds from outside there is the problem of contamination which requires elaborate cleaning and filter processes in order to ensure that the sample liquid does not come into contact with contaminated gas.

Other methods are described in, for example, U.S. Pat. No. 5,009,998 or U.S. Pat. No. 6,063,564, which are not suitable for supports or biochips with a planar analyte reservoir, the flat bottom of which is furnished with immobilized reactants, if it is intended to carry out further process steps from above after the incubation such as, e.g., washing, reagent addition, optical measurement, etc. The analytes in the boundary layer between immobilized reactants and sample liquid volume are depleted by binding to the reactants. New analytes are not resupplied sufficiently rapidly from the liquid volume due to the low analyte diffusion rate of about 1 μm/s. Investigations on the disclosed methods carried out by the applicant have shown that the poor homogeneity of the increase in intensity over the bottom surface of the support or biochip is a major disadvantage of all these methods, with the exception of the method disclosed in EP 1 604 734 A2 (US 2006/0019243 A1).

### SUMMARY

It is against the above background that the embodiments of the present disclosure provide certain unobvious advancements over the prior art. In particular, the inventors have recognized a need for improvements in methods and devices for detecting analytes in a sample liquid.

Although the embodiments of the present disclosure are not limited to specific advantages or functionality, it is noted that the present disclosure provides a method and a device which avoids the above-mentioned disadvantages and simplifies the detection method as well as the device.

In accordance with one embodiment, a method for detecting analytes is provided in that the sample liquid is moved during the mixing treatment relative to the immobilized reactants by an oscillating movement of the vessel in one direction, typically along a line or a curve.

In accordance with another embodiment, a device for carrying out the method is provided comprising at least one vessel holder for receiving at least one vessel for sample liquid, and at least one drive which is designed such that the vessel holder and the vessel contained therein can be moved in an oscillating manner.

These and other features and advantages of the embodiments of the present disclosure will be more fully understood from the following detailed description taken together with the accompanying claims. It is noted that the scope of the claims is defined by the recitations therein and not by the specific discussion of features and advantages set forth in the present description.

### BRIEF DESCRIPTION OF THE DRAWINGS

The following detailed description of the embodiments of the present disclosure can be best understood when read in conjunction with the following drawings, where like structure is indicated with like reference numerals and in which:

FIG. 1a shows a schematic perspective view of a device in accordance with an embodiment of the present disclosure;

FIG. 1b shows an enlargement of the circled area in FIG. 1a denoted I;

FIG. 2 shows a lateral elevation of the device of FIGS. 1a and 1b;

FIG. 3 shows a top view from above of a device according to an embodiment of the present disclosure;

FIG. 4 shows a top view of a rotor having vessel receivers according to an embodiment of the present disclosure;

FIG. 5 shows a vessel receiver in a schematic partial view and a vessel for sample liquid held therein in accordance with an embodiment of the present disclosure;

FIG. 6 shows a schematic front-view of a cover element for the vessel in accordance with an embodiment of the present disclosure;

FIG. 7 shows a schematic, perspective view of the cover element from below, i.e., from the side which rests against the upper side of the sample vessel, in accordance with an embodiment of the present disclosure;

FIGS. 8a and 8b show a perspective diagram of the interaction between the vessel loading element and a cover element configured to seal the vessel in accordance with an embodiment of the present disclosure, where an enlargement of the circled area of FIG. 8a denoted VIII is shown in FIG. 8b;

FIG. 9a shows a rotor as a vessel holder with an alternative cover element in accordance with another embodiment of the present disclosure;

FIG. 9b shows an enlargement of the area of FIG. 9a bordered by the dashed line and denoted IX in accordance with an embodiment of the present disclosure; and

FIG. 10 shows a schematic perspective diagram of an alternative embodiment of the device according to the present disclosure.

Skilled artisans appreciate that elements in the figures are illustrated for simplicity and clarity and have not necessarily been drawn to scale. For example, the dimensions of some of the elements in the figures may be exaggerated relative to other elements to help improve understanding of the embodiment(s) of the present disclosure.

### DETAILED DESCRIPTION

In the method the sample liquid is subjected to a mixing treatment on a surface of a support having in particular immobilized reactants wherein an in particular trough-shaped vessel with an essentially flat bottom as a support surface for the immobilized reactants is used as a vessel. Such supports are also referred to as biochips.

As a result of the inertia of the sample liquid an oscillating movement of the vessel moves the sample liquid relative to the vessel and also relative to the reactants bound to the vessel so that an enhanced accumulation of analyte occurs in the boundary layer between the sample liquid containing analytes and the reactants. The oscillating movement occurs in one direction, typically along a curved line or a circular path. Furthermore, the oscillating movement can also result in an improved homogeneous distribution of analytes relative to the reactants so that detection of analytes in the sample liquid can be improved. The overall reaction kinetics can be accelerated. Furthermore, it was found that the evaporation rate of sample liquid is considerably lower than is the case with the disclosed method of EP 1 604 734 A2 (US 2006/0019243 A1): in the case of oscillating sample vessels it was about 0.3 μl/min compared with about 0.6-0.7 μl/min according to the disclosed air jet method at an ambient temperature of 18° C. and a relative air humidity of 50%.

The oscillating movement of the vessel is typically essentially parallel to the flat bottom of the vessel and it is suggested that the vessel is oscillated at a frequency of about 1 to 50 hertz, typically about 10 to 20 hertz, and an amplitude of less than about 6 millimeters, typically of about 0.2 to 4 millimeters, more typically of about 1 to 2 millimeters. Due to the oscillating movement essentially parallel to the flat bottom of the vessel, it is possible to prevent sample liquid from coming into contact with a cap covering the vessel on which a portion of the sample liquid could remain adhered. In addition, the frequency and amplitude of the oscillating movement do not lead to flows in the sample liquid that could result in a sort of spilling over of the sample liquid that would wet upper boundary areas and transition areas between the vessel and cap.

Furthermore, the quasi linear oscillation allows to vary the amplitude of the oscillation without mechanical change of an according device, as disclosed in, for example, U.S. Pat. No. 7,338,199 B2.

It is contemplated that the vessel be oscillated in a vessel holder or that several vessels be oscillated simultaneously in a common vessel holder. In this connection each vessel can be oscillated by a drive allocated to the respective vessel or several and, in particular, all vessels in the vessel holder can be oscillated by a common drive. The oscillation of several vessels by driving a common vessel holder for the vessels enables a uniform and identical movement of all vessels so that there are essentially identical reaction conditions in all vessels.

In order that there is no loss or only a small loss of sample liquid from the vessel due to evaporation during the oscillating movement, it is further contemplated that the vessel be covered before the oscillation and in particular be sealed by a cover element.

The device for carrying out the method comprises at least one vessel holder for receiving at least one vessel for sample liquid and, according to an embodiment of the present disclosure, the device has at least one drive which is designed such that the vessel holder and the vessel contained therein can be moved in an oscillating manner.

The device typically comprises a single vessel holder with several vessel receivers and a single drive which can simultaneously oscillate all vessels held in the vessel receivers. Such a drive concept for simultaneously oscillating all vessels simplifies the construction of the device. Furthermore, only one drive is required for such a device which has an advantageous effect on costs.

Alternatively, each sample vessel can be allocated its own drive such as, for example, a Piezo element or similar component.

Furthermore, it is contemplated that the device comprises a vessel loading element wherein the vessel loading element and the vessel holder can be moved relative to one another in order to insert or remove a vessel into or from a particular vessel receiver.

The drive of the vessel holder is typically designed such that in addition to the function of producing the oscillating movement it has at least one further function of moving the vessel holder relative to the stationary vessel loading element such that each vessel receiver can be positioned in a predetermined position relative to the vessel loading element in order to insert a vessel into the respective vessel receiver or take it out of the vessel receiver. The vessel holder typically has a circular design and has vessel receivers at regular intervals along its circumferential edge. With such a circular vessel holder, vessel receivers can be loaded with vessels or vessels can be removed from the vessel receivers by the vessel loading element. A vessel holder can have, for example, twelve vessel receivers. In order to load the vessel holder with vessels containing sample liquid, the vessel holder is aligned by the drive with each vessel receiver relative to the vessel loading element so that a vessel can be inserted by the vessel loading element into the respective vessel receiver. As soon as a first vessel or a first support has been received in a vessel receiver of the vessel holder, the oscillating movement of the vessel holder can begin. When further vessels are inserted into or removed from other vessel receivers, the oscillating movement can be interrupted. The vessel holder can be moved in an oscillating manner during a desired incubation period where the incubation period can be determined for a respective vessel so that after the incubation time is reached this vessel can be removed from the vessel holder and other vessels still remain in the vessel holder until their incubation time has expired. Of course the number of twelve vessel receivers is purely an example and other numbers of vessel receivers can be provided such as 8, 10, 16, etc. The number of vessel receivers depends in particular on the dimensions of the vessels and in addition also on the dimensions of the vessel holder itself. Furthermore, also a type of place-holder (dummy) into which no vessel can be inserted can be provided instead of at least one vessel receiver. Such a place-holder can for example be used to adjust the vessel holder during the incubation period for all vessels such that the place-holder is aligned relative to the vessel loading element.

Alternatively, the vessel holder can also be designed as an essentially vertically orientated plate in which several rows and columns of vessel receivers are formed. For example, three columns can be provided each with four vessel receivers resulting in a type of vessel receiver matrix or array. The vessel holder designed as a vertically oriented plate can for example be moved in an oscillating manner in the horizontal direction by means of a plunger coil so that the vessel receivers and the vessels held therein are correspondingly moved as well. In the case of such an arrangement of vessel receivers in a stationary vessel holder it is typical that the vessel loading element has its own drive by means of which the vessel loading element can be moved to desired positions of the vessel receivers. In particular, it is desirable that the vessel loading element can be moved in a vertical and/or horizontal direction relative to the stationary vessel holder. It is also conceivable that the vessel holder can for example only be displaced in a horizontal direction and the vessel loading element only in a vertical direction.

In order to limit the evaporation of sample liquid during the incubation period, the device can comprise cover elements which cover the vessels when they have been inserted into the vessel receivers.

The cover elements can be manufactured from metal, in particular aluminium, or from plastic. They are typically arranged at a small distance to the upper vessel rim which simplifies the insertion and removal of vessels into or out of the vessel receivers. The cover elements can also be used as heat conductors in order to heat the samples during the incubation period.

The cover elements can alternatively be in the form of sealing components which seal the vessels in an inserted state in the vessel receivers. Such sealing components can be elastic membranes or covers which lie sealingly over the upper vessel rim. This further reduces the evaporation of sample liquid. In the case of a cover it is additionally contemplated that the cover has an area (cavity) which is recessed towards the top and is shaped away from the trough of the vessel. Such a design of the cover increases the distance between the inner side of the cover and the sample liquid to prevent in an even better manner sample liquid from coming into contact with the cover during the oscillating movement.

The vessel loading element typically comprises vessel grippers where the sealing components and the vessel grippers are designed such that the sealing components are held away from the vessel by their interaction during the process of inserting the vessels or removing the vessels into or out of the vessel receivers. In this connection guide faces that interact with one another can be formed in particular on the vessel grippers or on the sealing components and, in particular, on the cover. Such guide faces can have the required inclines to lift the sealing components or the cover so that when the vessel gripper is inserted into the vessel receiver, the sealing components or the cover is automatically lifted in a certain manner. The sealing components can optionally be pretensioned in their closed position, i.e., in the contact bearing position on the upper vessel rim for example by means of an elastic design of the sealing components or by using a spring or similar part.

A torque motor can be employed as a drive for the vessel holder. Torque motors are characterized in that they, on the one hand, can produce a large torque and that they, on the other hand, can also execute very precise and very small movements which is especially advantageous for generating the oscillating movements. In addition to the oscillating movements it is also possible to execute feed movements with the torque motor in order to move each of the vessel receivers to the vessel loading elements so that a vessel can be inserted into the respective vessel receiver or removed from the receiver. Hence, it is not necessary to have different drives for loading or unloading the vessel holder and for its oscillating movement, but rather both movements can be executed by one and the same drive, i.e., the torque motor. The proposed configuration makes the device and the method to be carried out overall more robust and less expensive. Alternatively, it is also possible to use a suitably designed stepper motor or a plunger coil in the case of a stationary vessel holder.

In order to control the proposed method it is contemplated that the device has a control unit which is designed such that it can control or regulate the drive of the vessel holder and in particular the oscillating movement and/or feed movements to the vessel loading elements.

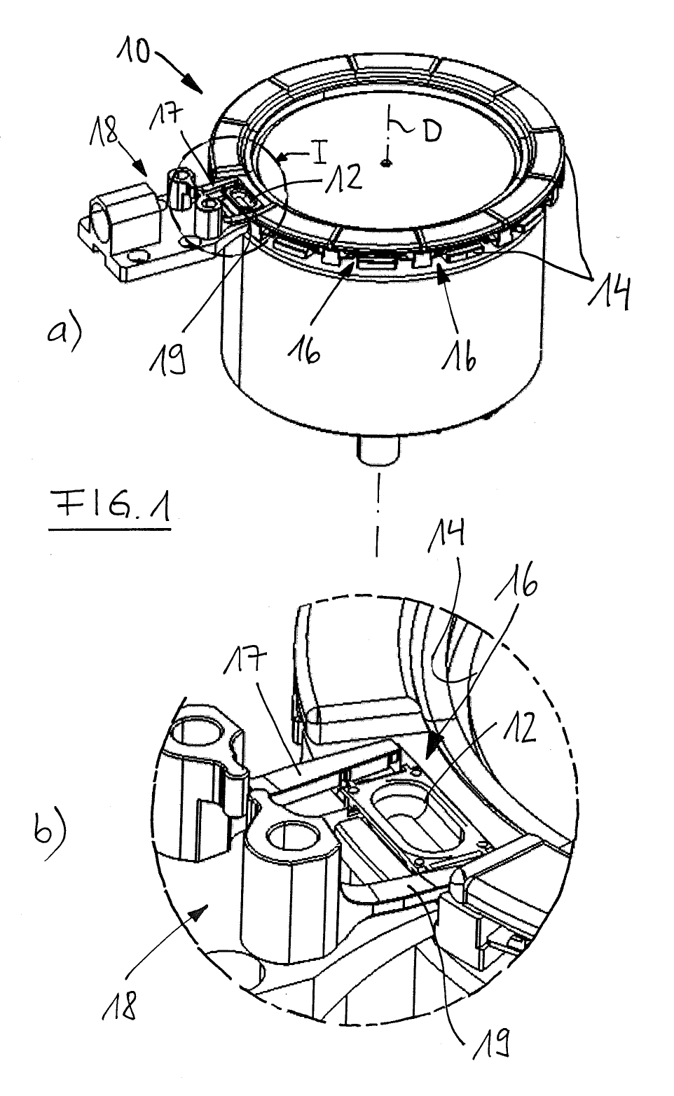

FIG. 1 shows a perspective and schematic diagram of a device 10 for holding vessels 12 for sample liquid. For this purpose the device 10 has a rotor 14 in a disk-shaped design as a vessel holder along the circumference of which a plurality of vessel receivers 16 are formed. A vessel 12 is inserted into or removed from a corresponding vessel receiver 16 by means of a gripper device 18 (vessel loading element). For this purpose the gripper device 18 has two gripper arms 17, 19 which extend in the direction of the rotor 14 (FIG. 1b) which can grip and clamp the sides of the sample vessel 12 such that it is removed from the rotor (14) in an essentially radial direction relative to the rotor 14 or it can be moved in such a manner towards the rotor. The rotor 14 can be rotated about an axis of rotation D so that all receivers 16 can be moved to the gripper device 18 in order to be loaded there with sample vessels 12.

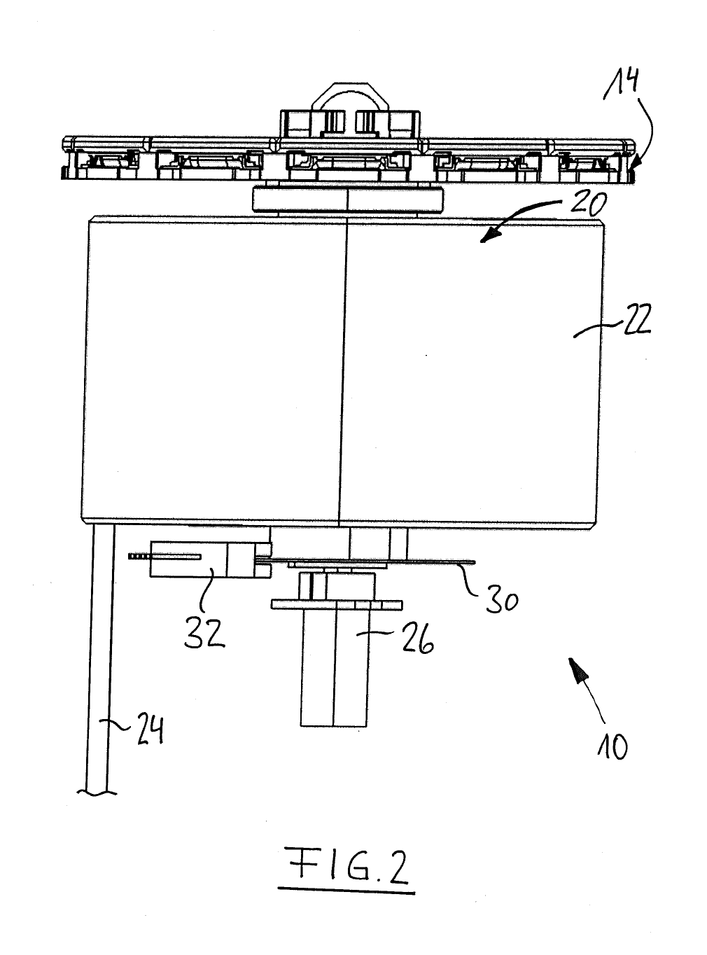

FIG. 2 shows the device 10 of FIG. 1 in an elevation view from the side. The rotor 14 is connected via a spindle which is not visible to an electric motor which in this case is in the form of a so-called torque motor 20 that is accommodated in a housing 22. Further, an electric cable 24 which supplies the torque motor 20 with electrical energy is attached to the housing 22. A slip ring transmitter 26 is located on the underside of the housing 22. Furthermore, it can be seen that a coding wheel 30 is connected in a torque-proof manner to the torque motor 20 on the underside. This coding wheel 30 is scanned by a sensor 32 in order to register the rotations of the torque motor 20 and to transmit this information to a control device that is not shown here. The control device serves to control or regulate the movements of the torque motor 20 and thus of the rotor 14.

The torque motor 20 is a so-called direct drive which is directly connected to the rotor 14 without further mechanical gearing to increase or reduce the speed so that the rotary movements generated by the torque motor 20 can be directly transferred to the rotor 14. The torque motor 20 can be controlled in such a manner that it executes an oscillating movement in such a manner that the sample vessels held in the rotor 14 are oscillated at a frequency of about 1-50 hertz, typically of about 10-20 hertz and with an amplitude of less than about 6 mm, typically of about 0.2-4 mm, in particular about 1-2 mm. This oscillating movement is indicated in all corresponding figures by arrows OSZ which illustrate the quasi linear movement along one direction, typically along a curved line. In this movement the vessels 12 are moved essentially parallel to their usually flat bottoms. However, the torque motor 20 can not only be used to generate the oscillating movement but it also serves to move or position the vessel receivers 16 relative to the gripper device 18 (e.g., FIG. 1a) in order to insert sample vessels into the receiver 16 or to remove them from the receiver. Thus, a single drive can execute all relevant movement patterns of the rotor 14 by means of appropriate control by the control unit that is not shown.

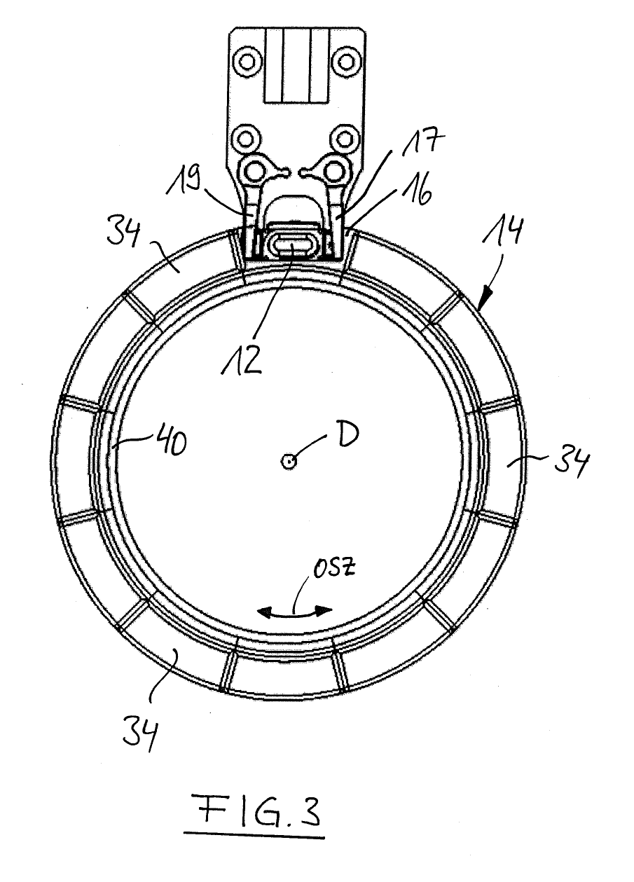

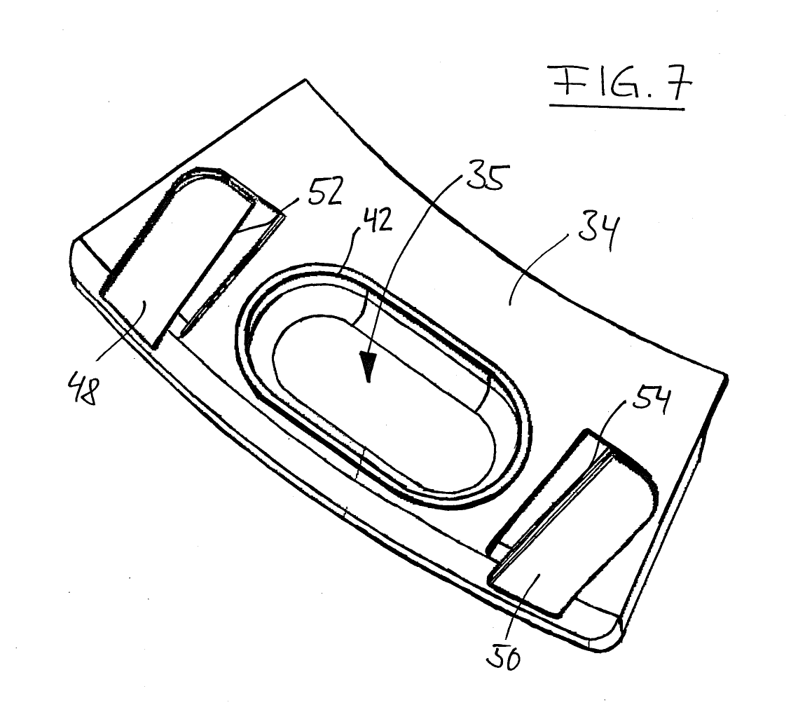

The top-view of FIG. 3 shows that the rotor 14 in which the vessels 12 or the supports or biochips are held in its receivers 16, has twelve vessel receivers 16. The number of twelve vessel receivers 16 shown here is purely an example and indeed fewer or more vessel receivers can be provided depending on the size of the rotor and on the size of the sample vessels 12. The rotor 14 has one or more cover elements 34 on its upper side which each cover, especially in a sealing manner, a receiver 16 and a sample vessel 12 held therein. In this connection these cap-like cover elements 34 have a hollow space (moist space cavity 35 (FIG. 7)) opposite to the trough-shaped sample vessel 12 so that sufficient space is present above the upper rim of the sample vessel 12 in order to substantially prevent the cover element 34 from being wetted with sample liquid. Furthermore, the cover 34 serves to counteract the evaporation of sample liquid.

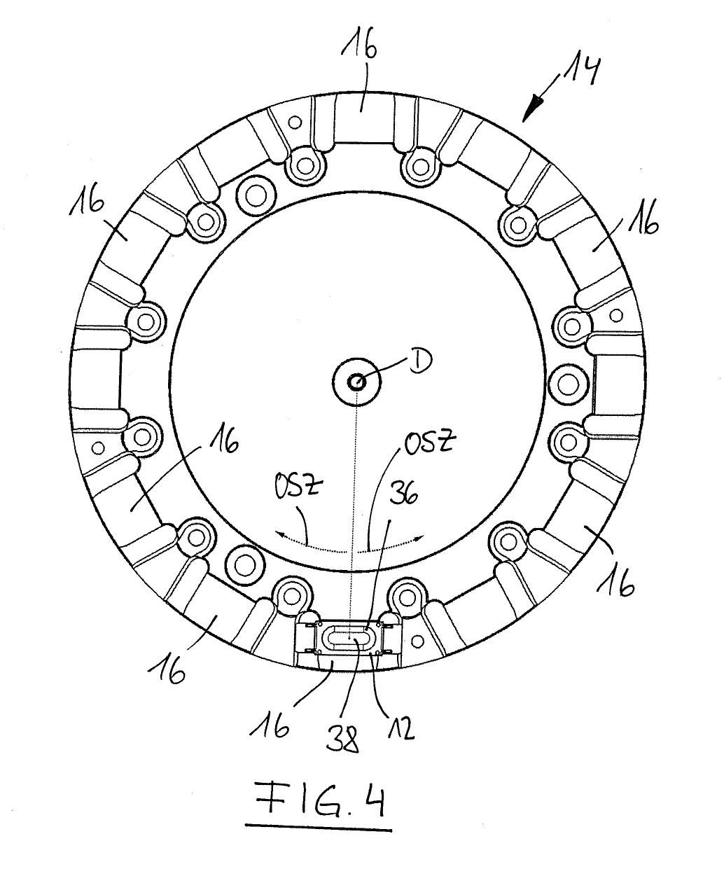

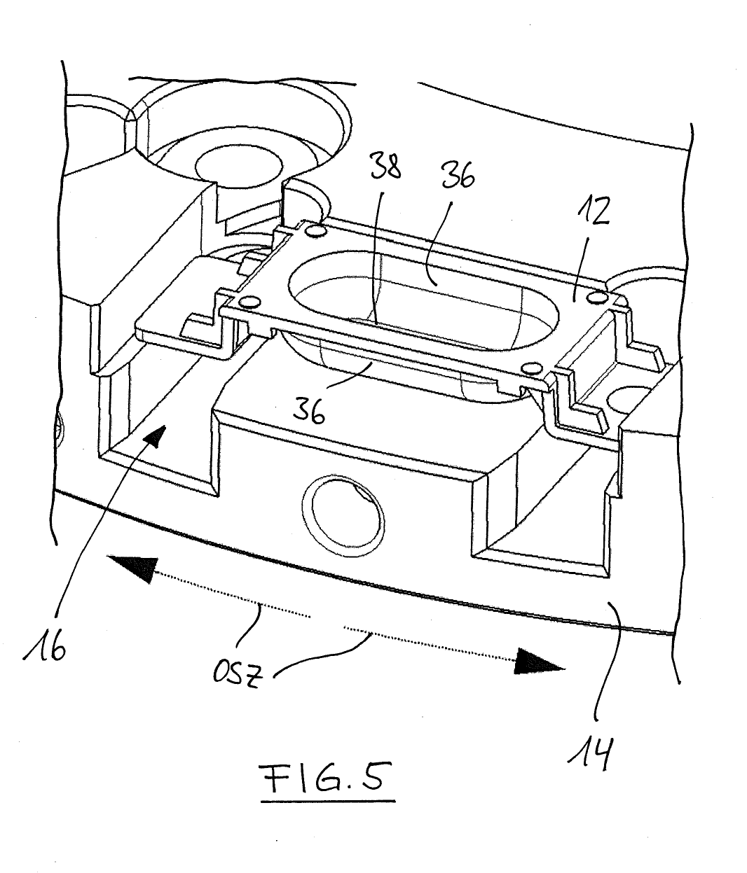

FIG. 4 shows a schematic top-view of the rotor 14 with its twelve vessel receivers 16 without cover elements. A sample vessel 12 is inserted into a vessel receiver 16 as an example. This sample vessel 12 is shown in an enlarged perspective view in FIG. 5. The sample vessel 12 has a trough-like depression 36 with an essentially flat bottom 38. Immobilized reactants (not shown) which interact with the analyte present in the sample liquid are arranged on this bottom in the form of a matrix or array. This interaction is positively influenced by the oscillating movement OSZ of the sample vessels 12 and of the sample liquid contained therein. In particular, the concentration of analyte in the boundary region to the reactants is improved by the oscillating movements so that sufficient analyte can react with the reactants and as a result the incubation period required to detect the analyte can be shortened.

The cover elements 34 already referred to in relation to FIG. 3 can be in the form of individual caps attached to the rotor 14, or they can be connected together by a continuous ring 40 connecting all caps (FIG. 3).

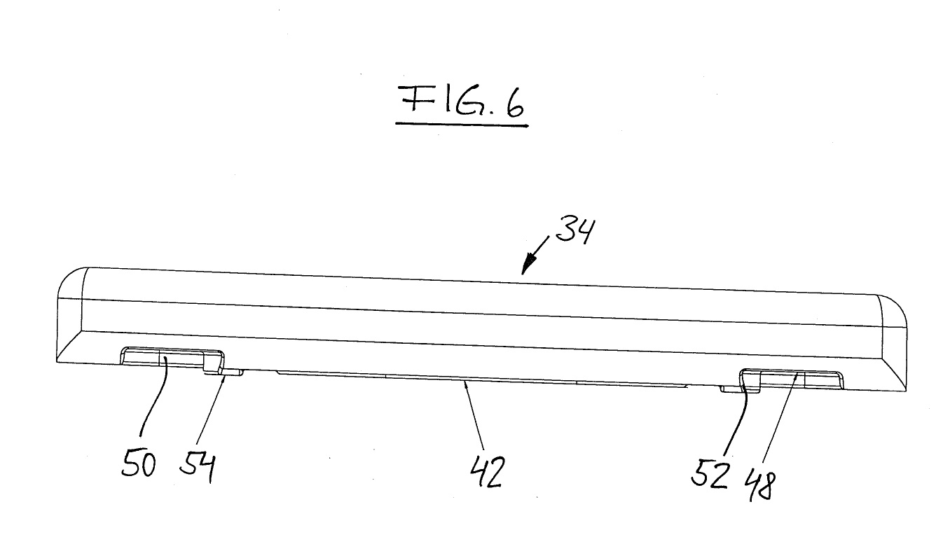

The partial figures in FIGS. 6 and 7 show such a cover element 34 in a perspective view from below (FIG. 7) as well as in a sectional view from the front (FIG. 6). The diagram of FIG. 7 shows a moist space cavity 35 in the cover element 34 which is arranged above the trough 36 of the sample vessel 12 in order to have sufficient space between the sample liquid and the cover element 34 to prevent contact of sample liquid with the cover 34. Areas of free space 48, 50 are also seen in this diagram into which the grippers 17, 19 can be inserted and which are dimensioned such that the grippers 17, 19 can execute a gripping movement towards and away from the sample vessel 12. In addition, the guide surfaces 52, 54 are shown which, in conjunction with the grippers 17, 19, enable the cover element 34 to be lifted. A sealing lip 42 is arranged around the moist space cavity 35 which closes the support trough 36 in a liquid-tight manner when the cover element 34 is closed.

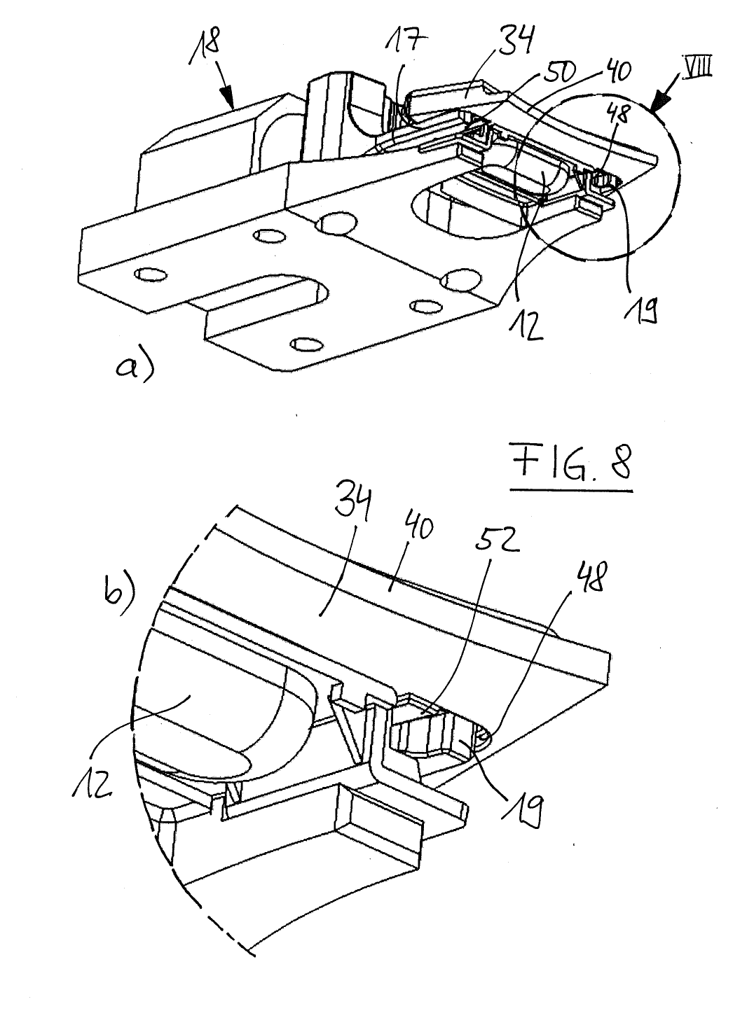

Such cover elements 34 can, as shown in FIGS. 8a and 8b, be lifted by the grippers 17, 19 (FIG. 3) so that the cover 34 is pivoted relative to the sample vessel 12 in order to remove or insert the sample vessel 12 into or out of the vessel receiver 16 by means of the grippers 17, 19. For this purpose the grippers 17, 19 or the cover element 34 have corresponding guide surfaces 52, 54 on their underside which result in a lifting or lowering of the cover 34 depending on the position of the grippers 17, 19. The cover elements 34 are pretensioned by gravity and the elastic ring 40 in the closed position resting on the sample vessel 12.

The cover elements 34 can be replaced individually or as an entire cap ring if they are connected together by means of the ring 40 and they can be exchanged as required. A continuous cap ring is particularly advantageous for such a replacement of the cover elements 34 because the time required for replacement can be kept short.

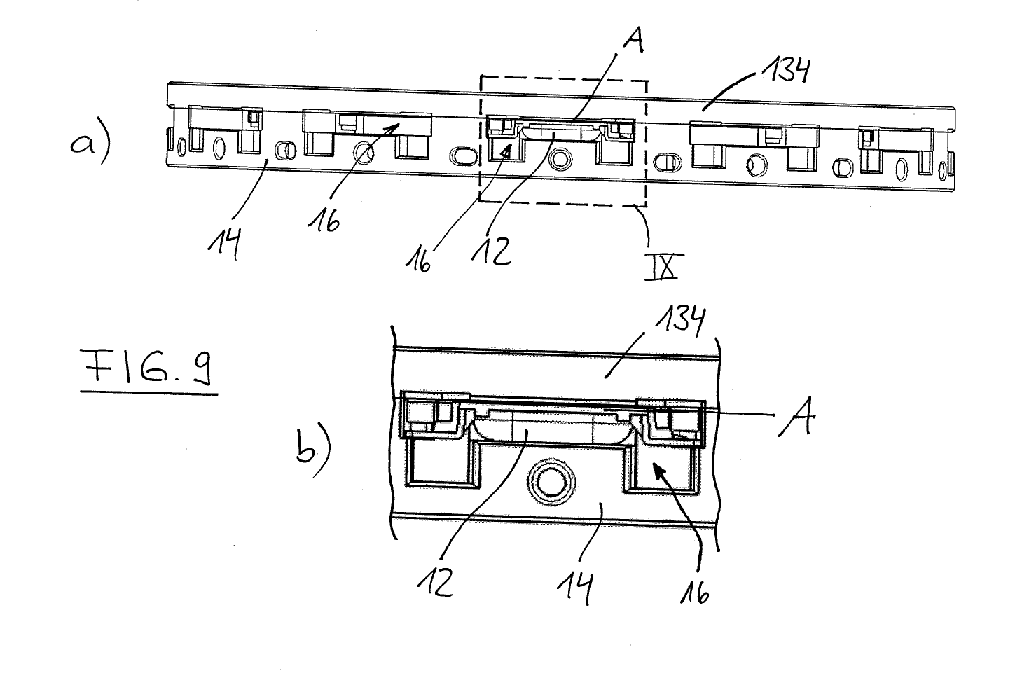

As an alternative to a sealing cover by means of the cover elements 34 designed as a sealing component it is also possible to arrange a metal ring 134 especially made of aluminium above the sample vessels 12 as shown in FIG. 9. Such a metal cover can also be in the form of a ring or as individual cover elements per vessel receiver 16. Such covers do not make a sealing contact with the upper rim of the sample vessel 12 but rather a small and as far as possible minimal gap A is present between the underside of the cover element and the upper rim of the sample vessel 12 which enables sample vessels 12 to be inserted and removed under the stationary cover element. It has been shown that due to this simple construction of a cover 134 without sealing, the sample vessel 12 can sufficiently limit the evaporation of sample liquid. Furthermore, such a cover 134 made of metal can also be used as a heat conductor to prevent condensation of sample liquid on the cover 134 and/or to optionally enable the sample liquid to be heated to a certain temperature during the entire incubation period. If the cover 134 is made from a non-heat conducting or poorly heat-conducting material, a heating device, in particular an infrared heater or similar component can be additionally used to heat the cover.

The metal cover 134 can also be removed and replaced on the rotor 14 for cleaning or replacement provided it has an overall ring-shaped design.

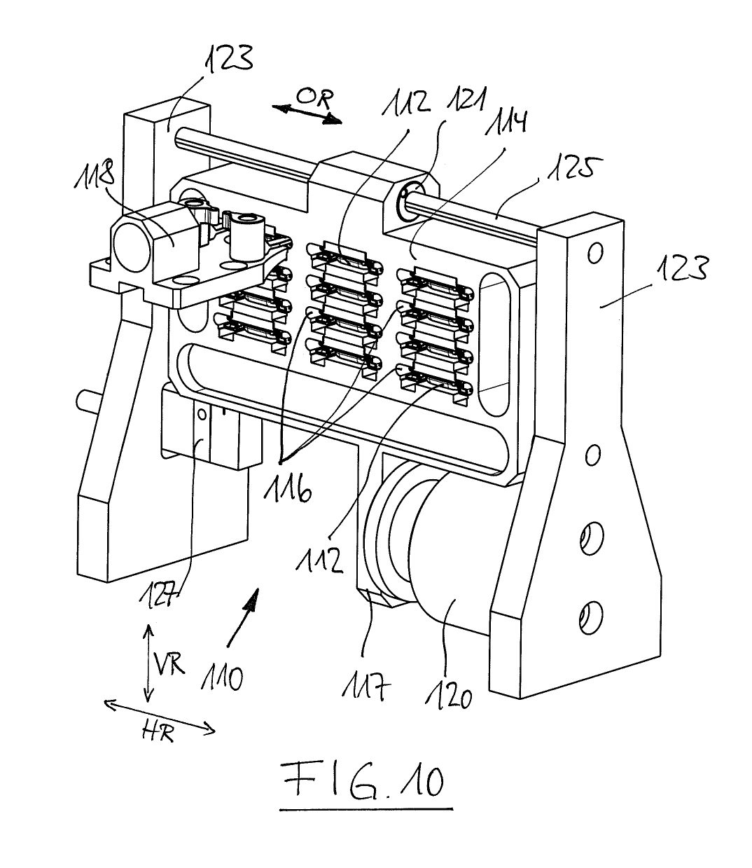

FIG. 10 shows an alternative embodiment of a device for carrying out the method according to the present disclosure. In this device 110 vessel receivers 116 are arranged vertically above one another and horizontally next to one another in a matrix or array-like manner. The vessel holder 114 has a plate-like or block design and the vessel receivers 116 are formed in it as openings. In order to be able to move the vessel holder 114 and the vessels 112 held in the vessel receivers 116 in an oscillating manner, the vessel holder 114 is connected to a plunger coil 120 on a flange 117 as a drive for the oscillating movement. Furthermore, the vessel holder 114 has a bearing 121 which can be moved along a rail 125 in the direction of oscillation. The rail 125 is attached to further frame elements 122. A vessel loading element 118 is used to load and unload the vessel receivers 116 and can be moved in a horizontal direction HR as well as in a vertical direction VR relative to the vessel holder 114 such that the vessel loading element 118 can be moved to any vessel receiver 116. Alternatively it is also conceivable that the vessel holder 114 can be moved in one direction, i.e., the vertical direction or horizontal direction, and the vessel loading element 118 can be moved in the other direction so that the individual vessel receivers 116 can be accessed by simultaneous relative movement of the vessel loading element 118 and the vessel holder 114. As in the first embodiment the vessels 112 are also typically covered by a cover 134. A heating foil (not shown) can in addition be for example mounted on the rear side of the vessel holder 114. For the sake of completeness it is also mentioned that a linear sensor is indicated by 127, which detects the oscillating movement of the vessel holder 114 and can correspondingly control the plunger coil 120 by means of a control unit that is not shown.

It is noted that terms like “preferably”, “commonly”, and “typically” are not utilized herein to limit the scope of the claimed subject matter or to imply that certain features are critical, essential, or even important to the structure or function of the embodiments disclosed herein. Rather, these terms are merely intended to highlight alternative or additional features that may or may not be utilized in a particular embodiment of the present disclosure.

It is also noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modifications and variations come within the scope of the appended claims and their equivalents.

What is claimed is:

1. A method for detecting analytes in a sample liquid comprising:
subjecting the sample liquid to a mixing treatment on a surface of a support having immobilized reactants thereon, wherein a trough-like vessel with an essentially flat bottom as a support surface for the immobilized reactants is used as a vessel for the sample liquid, and
moving the sample liquid relative to the immobilized reactants by a controlled oscillating movement of the vessel during the mixing treatment in one direction along a line or a curve, with the vessel being covered by a cover element in order to limit evaporation of sample liquid from said vessel.

2. The method according to claim 1, wherein the vessel is oscillated at a frequency of about 1 to 50 hertz and an amplitude of less than about 6 millimeters.

3. The method according to claim 1, wherein the oscillating movement of the vessel takes place essentially parallel to the flat bottom of the vessel.

4. The method according to claim 1, wherein the vessel is oscillated in a vessel holder or that several vessels are oscillated simultaneously in a common vessel holder.

5. The method according to claim 4, wherein each vessel is oscillated by a drive allocated to the respective vessel or that several and in particular all vessels in the vessel holder are oscillated by a common drive.

6. A device for carrying out the method according to claim 1 comprising:
a vessel holder comprising several vessel receivers for trough-like vessels with an essentially flat bottom for receiving sample liquid, and
at least one drive which is designed such that the vessel holder and vessels inserted in the vessel receivers can be moved in a controlled oscillating manner in one direction along a line or a curve by means of that drive, and
at least one cover element for covering vessels inserted in said vessel receivers, in order to limit evaporation of sample liquid from said vessels during the oscillating movement.

7. The device according to claim 6 further comprising a vessel loading element, wherein the vessel loading element and the vessel holder can be moved relative to one another in order to insert a vessel into a particular vessel receiver.

8. The device according to claim 7, wherein the drive of the vessel holder is designed such that in addition to the function of generating the oscillating movement, it has at least one further function of moving the vessel holder relative to the stationary vessel loading element such that each vessel receiver can be positioned in a predetermined position relative to the vessel loading element in order to insert a vessel into the respective vessel receiver or take it out of the vessel receiver.

9. The device according to claim 6, wherein the vessel holder has a circular design and has the vessel receivers along its circumferential edge which are distributed at regular intervals.

10. The device according to claim 6, wherein the cover elements are configured as sealing components and close vessels in the inserted state in a sealing manner.

11. The device according to claim 7, wherein the vessel loading element comprises vessel grippers, the sealing components and the vessel grippers being designed such that as a result of their interaction during the process of inserting the vessels or removing the vessels into or out of the vessel receivers the sealing components are held away from the vessel.

12. The device according to claim 6, wherein the drive for the oscillating movement is a torque motor or a stepper motor or a plunger coil which is connected to the vessel holder.

13. The device according to claim 6 further comprising a control unit which is designed such that it can control or regulate the drive of the vessel holder, especially its oscillating movement.
